(19) United States
(12) Patent Application Publication
(10) Pub. No.: US 2011/0004480 A1
(43) Pub. Date: Jan. 6, 2011

(54) MAP-ORIENTED REPORT-AND-RESPONSE INTEGRATED SYSTEM AND METHOD

(75) Inventor: Stephen Shu-Hung Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Environmental Protection Administration, R.O.C (Taiwan), Taipei City (TW)

(21) Appl. No.: 12/551,483

(22) Filed: Aug. 31, 2009

(30) Foreign Application Priority Data
Jul. 3, 2009 (TW) 98122622

(51) Int. Cl. G06Q 99/00; G06F 3/048; G01C 21/00

(52) U.S. Cl. 705/1.1; 715/841; 701/208; 715/853

(57) ABSTRACT

A map-oriented report-and-response integrated method is provided. The method comprises displaying a multi-dimensional information menu, wherein the multi-dimensional menu has at least a first menu having several organization options, a second menu having several topic options and a third menu having several task options. Further, one of the organization options is selected and one of the topic options is selected. Then, a content of each of the task options is changed according to the selected organization option and the selected topic option. Moreover, a positioning information is received and a map relating to the positioning information is displayed. Also, a report case is established by receiving a positioning report signal including a positioning point from the map. A maintenance work is performed at an actual location corresponding to the positioning point and then an image record of the actual location is recorded and uploaded to relate to the report case.

### CROSS-REFERENCE TO RELATED APPLICATION

This application claims the priority benefit of Taiwan application serial no. 98122622, filed on Jul. 3, 2009. The entirety of the above-mentioned patent application is hereby incorporated by reference herein and made a part of specification.

### BACKGROUND OF THE INVENTION

1. Field of Invention

The present invention relates to an integrated method and system. More particularly, the present invention relates to a map-oriented report-and-response integrated system and a map-oriented report-and-response integrated method.

2. Description of Related Art

The conventional case report-and-handling procedure related to environmental pollution or malfunction reports is implemented by using telephone or fax to report the incidents, which are filed as cases by manually taking notes or recording the telephone reports. Although various internet reporting systems have been developed recently, the types of the incidents and the locations where the incidents happen are all described in written form. Because of the various ways to take notes of incidents or the reading comprehension difference for different people handling the paper case report, it is easy to misunderstand the type of the incident, the time at which the incident happened and the location where the incident happened. Thus, the misunderstanding of the case types, the time of occurrence and the location would lead to delayed reporting to the case-handling departments or mistakenly informing the departments which are not responsible for handling the type of the case. Hence, time for effectively handling of the report case is lost.

Furthermore, the conventional report-and-handling procedure either lacks case-handling transparency and systematization of the case-handling result or only provides simple case-handling final reports in written language. Therefore, the general public or the reporters, who continuously track the handling result of the reported case, could get the impression that the government department lacks efficiency or is delaying the reported case. Furthermore, people will be discouraged from participating public affairs.

Hence, how to establish a report-and-response integrated system, which is capable of precisely describing the incidents to be reported and is easy to use, and further can improve the performance of handling the reported case, has recently become a very important development task.

### SUMMARY OF THE INVENTION

Accordingly, at least one objective of the present invention is to provide a map-oriented report-and-response integrated method capable of combining a map with the content of the case report to improve the performance of responding to the case report.

The invention further provides a map-oriented report-and-response integrated system which provides a multi-dimensional menu capable of simplifying the data searching procedure.

Another objective of the present invention is to provide a map-oriented report-and-response integrated method. The method comprises displaying a multi-dimensional information menu, wherein the multi-dimensional menu has at least a first menu, a second menu and a third menu, and the first menu has a plurality of organization options, the second menu has a plurality of topic options and the third menu has a plurality of task options. Further, one of the organization options is selected from the first menu and one of the topic options is selected from the second menu. Then, content of each of the task options is changed according to the selected organization option and the selected topic option so that the changed content is in response to the selected organization option and the selected topic option. Moreover, positioning information is received and a map relating to the positioning information is displayed. Also, a report case is established by receiving a positioning report signal from the map, wherein the positioning report signal includes a positioning point. Maintenance work is performed at an actual location corresponding to the positioning point according to the positioning report signal and then an image record of the actual location is recorded. Then, the image record is uploaded to relate the report case so as to complete a response to the report case.

According to one embodiment of the present invention, the map-oriented report-and-response integrated method further comprises receiving sign-in information of a reporter. After the report case is established, a credit value linked to personal data is recorded according to the nature of the report case, wherein the personal data is related to the sign-in information. Also, after the report case is established, at least one environmental caretaker of at least one care district in which the positioning point is located is informed. Further, after the response is completed, the credit value belonging to the personal data of the environmental caretaker of the care district is recorded according to the nature of the report case.

According to one embodiment of the present invention, wherein the maintenance work comprises a global-positioning-system route record and the global-positioning-system route record is consistent with a global-information-system positioning information of the image record.

According to one embodiment of the present invention, wherein each of the organization options represents an organization and an organization structure of each organization is a tree-type structure and a structure relationship between the organizations is represented as a complex-tree type relation.

According to one embodiment of the present invention, the map-oriented report-and-response integrated method further comprises performing a reviewing procedure for actually inspecting the actual location according to the positioning report signal and the response.

The invention also provides a map-oriented report-and-response integrated system. The map-oriented report-and-response integrated system comprises a menu displaying module, an organization option selection module, a topic option selection module, a changing module, a positioning information receiving module, a map displaying module, a positioning report signal receiving, a case establishing module, an uploaded file receiving module and a response module. The menu displaying module is used for displaying a multi-dimensional information menu, wherein the multi-dimensional menu has at least a first menu, a second menu and a third menu, and the first menu has a plurality of organization options, the second menu has a plurality of topic options and the third menu has a plurality of task options. The organization option selection module is used for determining one of the organization options from the first menu. The topic option selection module is used for determining one of the topic options from the second menu. The changing module is used for changing a content of each of the task options according to the selected organization option and the selected topic option so that the changed content is in response to the selected organization option and the selected topic option. The positioning information receiving module is used for receiving a positioning information. The map displaying module is used for displaying a map relating to the positioning information. The positioning report signal receiving module is used for receiving a positioning report signal from the map, wherein the positioning report signal includes a positioning point. The case establishing module is used for establishing a report case according to the positioning report signal. The uploaded file receiving module is used for receiving an image record and relating the image record to the report case, wherein the image record is taken at an actual location corresponding to the positioning point as a maintenance work is done at the actual location. The response module is used for filing a response to the report case according to the image record.

According to one embodiment of the present invention, the map-oriented report-and-response integrated system further comprises a sign-in module, an inform module and a credit analyzing module. The sign-in module is used for receiving a sign-in information of a reporter. The inform module is used for informing at least an environmental caretaker of at least a care district in which the positioning point is located according to the report case. The credit analyzing module is used for increasing a credit value belonging to a personal data related to the sign-in information of the reporter and increasing the credit value belonging to the personal data of the environmental caretaker of the care district according to the nature of the report case.

According to one embodiment of the present invention, wherein the maintenance work comprises a global-positioning-system route record and the global-positioning-system route record is consistent with a global-information-system positioning information of the image record.

According to one embodiment of the present invention, wherein each of the organization options represents an organization and an organization structure of each organization is a tree-type structure and a structure relationship between the organizations is represented as a complex-tree type relation.

According to one embodiment of the present invention, the map-oriented report-and-response integrated system further comprises a reviewing module for recording a reviewing result, wherein the reviewing result is obtained by actually inspecting the actual location according to the positioning report signal and the response.

In the present invention, by using the multi-dimensional information menu, a complicated and large number of data can be hierarchically classified into several data nodes and the contents of different data nodes can be displayed on the same viewable region by selecting corresponding menu options. Furthermore, the map-oriented report-and-response integrated system of the present invention is based on the map concept to electronically map the report case and the response in response to the report case so that the performance for responding to the report case is improved. Also, by quantifying the performances of the reporter and the person in charging the report case into credit values, the participation and the fulfillment of the users of the map-oriented report-and-response integrated system can be enhanced and the motivation for implementing the tasks and the team spirit of the users can be greatly increased as well.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is schematic diagram showing a map-oriented report-and-response integrated system according to one embodiment of the invention.

FIG. 1B is a flow chart showing a map-oriented report-and-response integrated method according to one embodiment of the invention.

FIG. 2A is a schematic diagram showing a multi-dimensional menu according to one embodiment of the present invention.

FIG. 2B is a schematic diagram showing a multi-dimensional menu according to another embodiment of the present invention.

FIG. 3 is a schematic diagram showing a structure relationship of the organizations in the map-oriented report-and-response integrated method according to one embodiment of the present invention.

FIG. 4 is a schematic diagram showing the steps of displaying a map related to the positioning information in the map-oriented report-and-response integrated method according to one embodiment of the present invention.

FIG. 5 is a schematic diagram showing the steps of completing a response in response to the report case in the map-oriented report-and-response integrated method according to one embodiment of the present invention.

FIG. 6 is a schematic diagram showing quantified credit analyzing result in a personal data in the map-oriented report-and-response integrated method according to one embodiment of the present invention.

### DESCRIPTION OF THE PREFERRED EMBODIMENTS

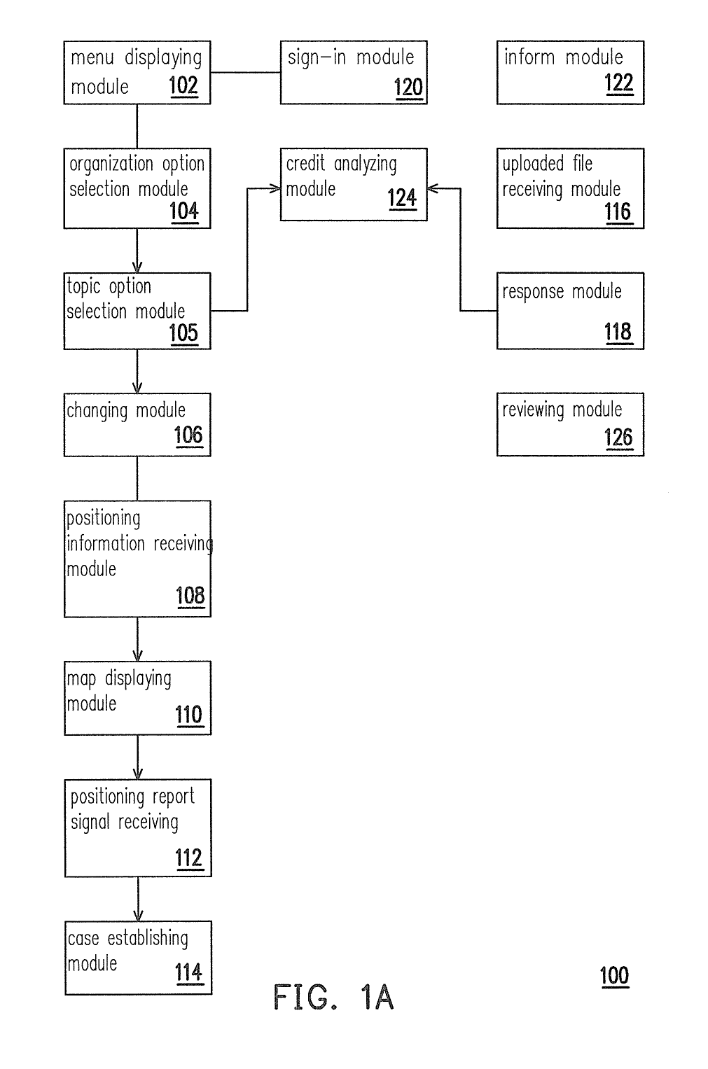

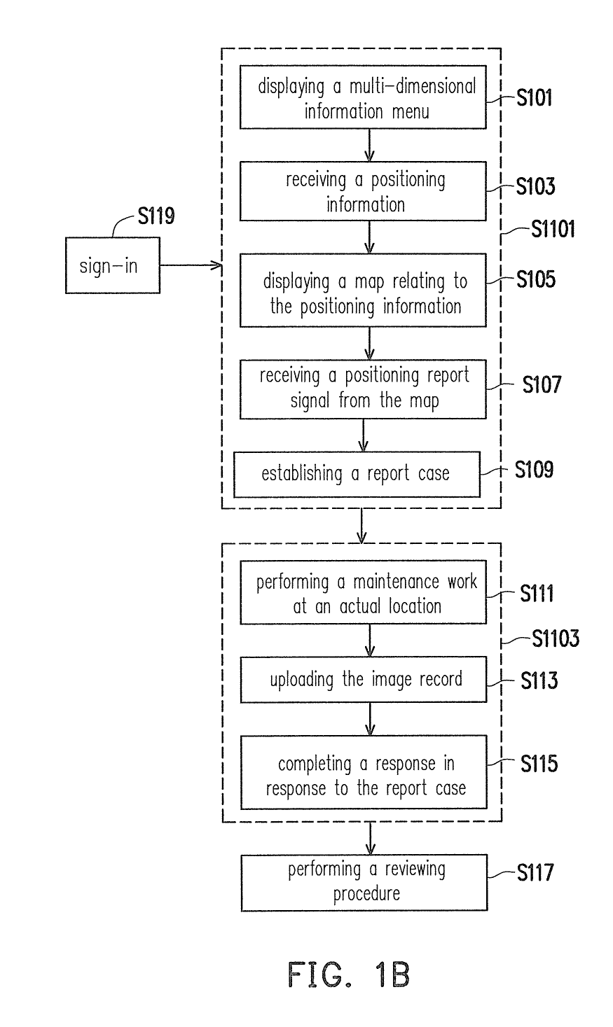

FIG. 1A is schematic diagram showing a map-oriented report-and-response integrated system according to one embodiment of the invention. FIG. 1B is a flow chart showing a map-oriented report-and-response integrated method according to one embodiment of the invention. As shown in FIG. 1A, a map-oriented report-and-response integrated system 100 of the present invention comprises a menu displaying module 102, an organization option selection module 104, a topic option selection module 105, a changing module 106, a positioning information receiving module 108, a map displaying module 110, a positioning report signal receiving 112, a case establishing module 114, an uploaded file receiving module 116 and a response module 118. Furthermore, the map-oriented report-and-response integrated system 100 comprises a sign-in module 120, an inform module 122, a credit analyzing module 124 and a reviewing module 126.

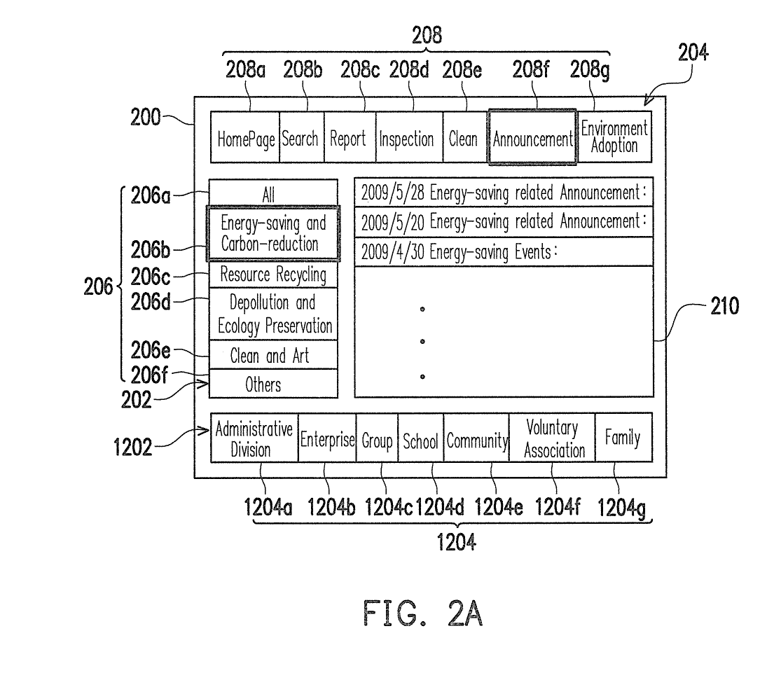

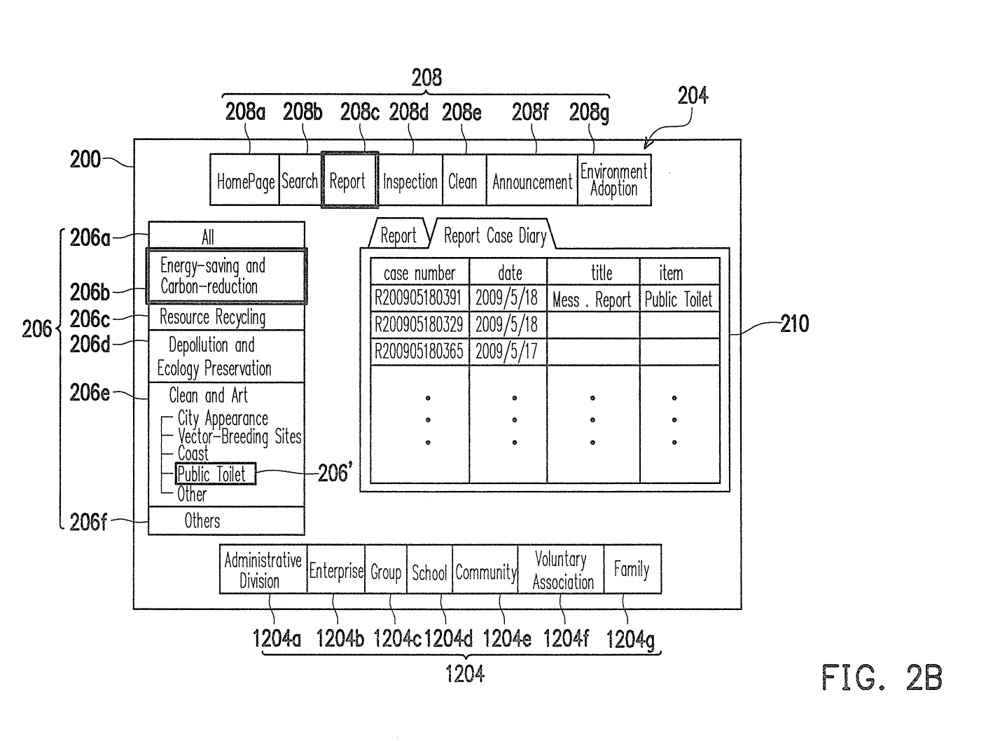

Still referring to FIG. 1A and FIG. 1B, in the step S101, the menu displaying module 102 displays a multi-dimensional information menu. The multi-dimensional information menu comprises at least a first menu, a second menu and a third menu. The first menu has several organization options, the second menu has several topic options, and the third menu has several task options. FIG. 2A is a schematic diagram showing a multi-dimensional menu according to one embodiment of the present invention. As shown in FIG. 2A, there is a second menu 202 at a vertical axis of the multi-dimensional menu 200, and there is a first menu 1202 and a third menu 204 listed on the multi-dimensional menu 200 respectively, and parallel to a horizontal axis of the multi-dimensional menu 200 respectively. It should be noticed that the second menu 202 has several topic options 206 including at least the option “All” which represents all of the options and is labeled 206a, the option “Energy-saving and Carbon-reduction” labeled 206b, the option “Resource Recycling” labeled 206c, the option “Depollution and Ecology Preservation” labeled 206d, the option “Clean and Art” labeled 206e, and the option “Others” which represents other items and is labeled 206f. The first menu 1202 has several organization options 1204 including the option “Administrative Division” labeled 1204a, the option “Enterprise” labeled 1204b, the option “Group” labeled 1204c, the option “School” labeled 1204d, the option “Community” labeled 1204e, the option “Voluntary Association” labeled 1204f, and the option “Family” labeled 1204g. Moreover, the third menu 204 has several task options 208 including at least the option “HomePage” labeled 208a, the option “Search” labeled 208b, the option “Report” labeled 208c, the option “Inspection” labeled 208d, the option “Clean” labeled 208e, the option “Announcement” labeled 208f, and the option “Environment Adoption” labeled 208g.

As shown in FIG. 2A, when one of the topic options 206 in the second menu 202 is selected, the content of each of the task options 208 in the third menu 204 is changed in response to the selected topic option 206. That is, when the option “Energy-saving and Carbon-reduction” labeled 206b in the second menu 202 is selected, the content 210 of the option “Announcement” labeled 208f only contains the announcements related to the issues about the energy saving and/or the carbon reduction. In other words, once one of the topic options 206 in the second menu 202 is selected, the content 210 of each of the task options 208 is changed accordingly so that the changed contents 210 of the task options are only related to the selected topic option 206.

When at least one topic option 206 has at least one sub-topic option and the sub-topic option is selected, the content of each of the task options 208 in the third menu 204 is changed in accordance with the selected sub-topic option. FIG. 2B is a schematic diagram showing a multi-dimensional menu according to another embodiment of the present invention. When the sub-topic option “Public Toilet” 206′ of the topic option “Clean and Art” 206e in the second menu 202 is selected, the content 210 of the task option “Report” 208c in the third menu 204 only contains the report cases related to the public toilets. That is, when one of the sub-topic options of the topic options 206 in the second menu 202 is selected, the content 210 of each of the task options 208 is changed according to the selected sub-topic option 206′ so that the changed content 210 is in accordance with the selected sub-topic option 206′. In other words, in the multi-dimensional information menu of the present invention, the whole information is hierarchically classified so that the topic options in the second menu are catalog roots of the information hierarchy and the task options in the third menu are child nodes with displayed contents varied with the selected catalog root. More clearly, the displayed contents are the contents of the child nodes belonging to the selected catalog root.

In other words, the topic option selection module 105 in the map-oriented report-and-response integrated system 100 is used to determined one of the topic options 206 in the second menu 202. Furthermore, the changing module 106 is used to change each content 210 of each of the task options 208 according to the selected/determined topic option 206 so that the changed content 210 of each of the task options 206 is corresponding to the selected topic option 206.

Additionally, in another embodiment, before or after the topic option selection module 105 determines one of the topic options 206 in the second menu 202, the organization option module 104 in the map-oriented report-and-response integrated system 100 is used to determined one of the organization options 1204 in the first menu 1202 and the changing module 106 changed the content 210 of each of the task options 208 according to the selected organization option 1204 and/or the selected topic option 206, so that the changed content 210 of each of the task options 208 is corresponding to the selected organization option 1204 and/or the selected topic option 206. That is, when the selected organization option 1204 is the sub-option “Taipei County” in the option “Administrative Division” 1204a and the selected topic option 206 is the sub-topic option “Public Toilet” 206′ in the option “Clean and Art” 206e, the content 210 of the task option “Report” 208c shown in FIG. 2B only contains the report cases related to the organization “Taipei County” and public toilets, such as “Report Case Diary” shown in FIG. 2B.

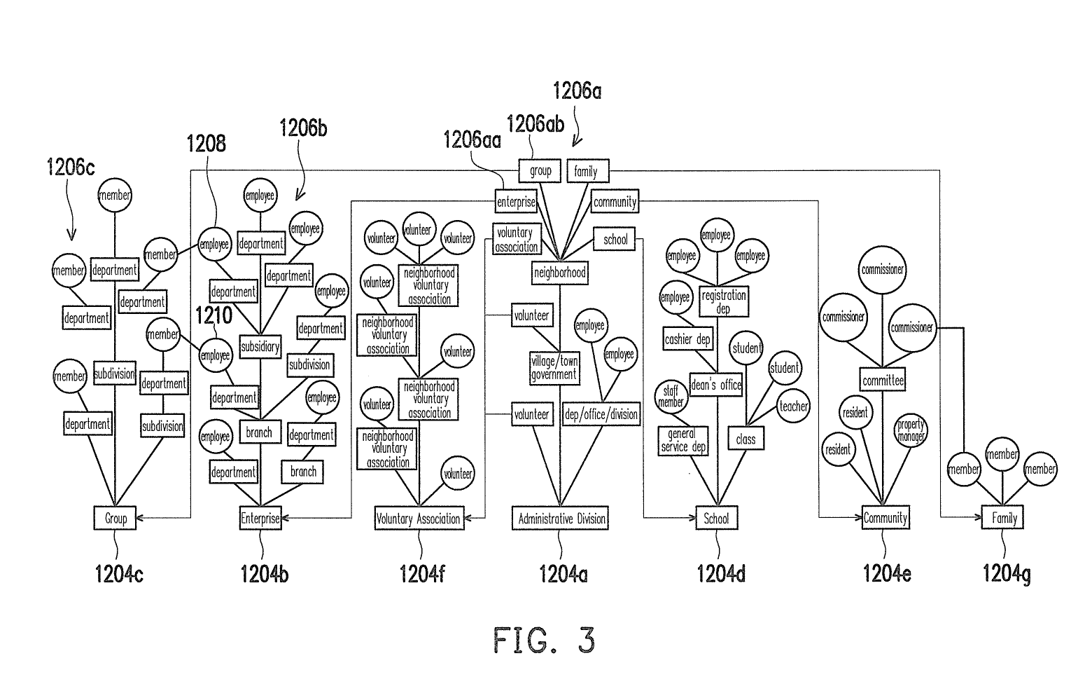

Each of the aforementioned organization options represents an organization, and an organization structure of each organization is a tree-type structure. That is, each department in each organization is a node of the tree-type structure and the nodes are interconnected with each other according to the hierarchy concept. Furthermore, the structure relationship between the organizations is represented as a complex-tree type relation. FIG. 3 is a schematic diagram showing a structure relationship of the organizations in the map-oriented report-and-response integrated method according to one embodiment of the present invention. As shown in FIG. 3, taking the tree-type structure 1206a of the administrative division represented by the option “Administrative Division” 1204a as an example, the administrative division is classified as the root of the tree-type structure, and each department, each office and each staff member are hierarchically classified as nodes of the tree-type structure according to the administrative levels. Furthermore, each office or each staff member can also be a root of the tree-type structure of another organization and/or can also be a node of the tree-type structure of the other organization. Thus, each node in each tree-type structure can derive another tree-type structure which is deemed to be a descendant organization or can be involved in another tree-type structure which is deemed to be an antecedent organization. Hence, the intricate relationship between the descendant organizations and the antecedent organizations is determined as a complex-tree type relation, and the structure constructed by all organizations are regarded as the complex-tree type structure. For example, the enterprise node 1206aa and the group node 1206ab in the tree-type structure 1206a of the administrative division are also the roots of the tree-type structure 1206b of the enterprise and the tree-type structure 1206c of the group respectively. Moreover, taking the tree-type structure 1206b of the enterprise represented by the option “Enterprise” 1204b and the tree-type structure 1206c of the group represented by the option “Group” 1204c as examples, the employee nodes 1208, and 1210 are also the member nodes of the tree-type structure 1206c of the group. By using the complex-tree type structure, the data in the map-oriented report-and-response integrated system can be classified and the interaction operations of the organizations can be strengthened. That is, announcing announcements, assigning tasks, reporting working results, reviewing performance and rewarding achievement can all be done through the organization tree-type structure. Moreover, the complex-tree type structure can be used as a medium for mobilizing the organizations to participate in an event.

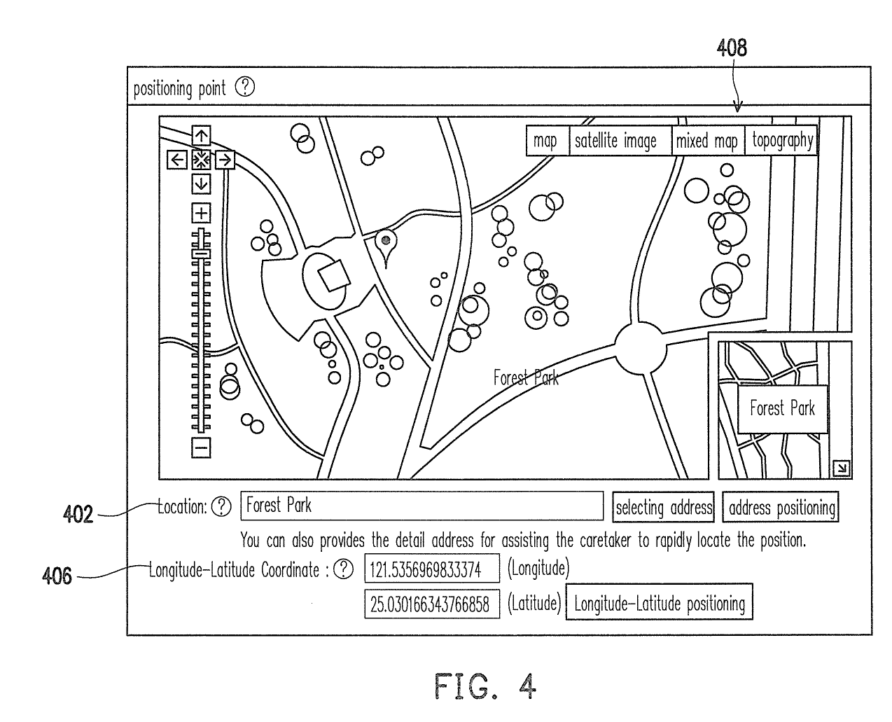

Further, as shown in FIG. 1A and FIG. 1B, in the step S103, the positioning information receiving module 108 receives a positioning information. The positioning information includes an address, a longitude-and-latitude coordinate, a map, a description of a region or the combination thereof. Then, in the step S105, the map displaying module 110 displays a map related to the positioning information. FIG. 4 is a schematic diagram showing the steps of displaying a map related to the positioning information in the map-oriented report-and-response integrated method according to one embodiment of the present invention. As shown in FIG. 4, the map-oriented report-and-response integrated system 100 receives a positioning information from the positioning information receiving module 108, and the positioning information can be, for example but not limited to, the address 402 or the longitude-and-latitude coordinate 406. Thus, the map displaying module 110 displays the map 408 related to the received positioning information.

Thereafter, in the step S107, the positioning report signal receiving module 112 receives a positioning report signal from the displayed map 408, and the case establishing module 114 establishes a report case (step S109). The positioning report signal includes a positioning point. This positioning point can be, for example but not limited to, a longitude-and-latitude coordinate. Moreover, the report case is established further according to a global-information-system (GIS) positioning information provided by a received report video or a received report image. The GIS positioning information can precisely give the location related to the report case. Therefore, the case report procedure S1101 is done.

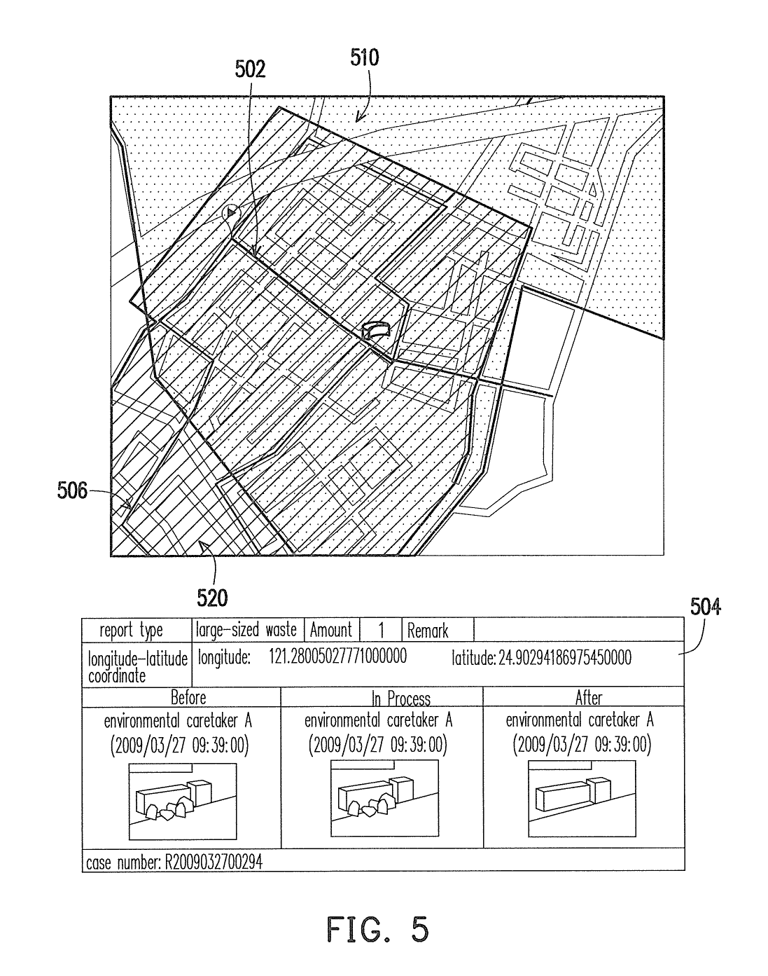

Further, in the step S111, the inform module 122 informs at least an environmental caretaker of at least a care district in which the positioning point is located according to the report case so that the environmental caretaker can perform a maintenance work at the actual location corresponding to the positioning point and take an image record of the actual location. The aforementioned care district can be a duty district or a voluntary district. That is, the care districts are divided into duty districts belonging to the government departments and the voluntary districts environmentally adopted by non-government organizations. Then, in the step S113, the uploaded file receiving module 116 receives the uploaded image record and relates the image record to the report case so that the response module files a response to the report case according to the image record (step S115). Therefore, the response procedure S1103 in response to the report case is done. FIG. 5 is a schematic diagram showing the steps of completing a response in response to the report case in the map-oriented report-and-response integrated method according to one embodiment of the present invention. As shown in FIG. 5, in the present embodiment, the maintenance work at the actual location further comprises a global-positioning-system (GPS) route record 502. The GPS route record 502 is consistent with the GIS positioning information 504 provided by the image record of the actual location. Thus, the GPS route record provides the reporter or the present map-oriented report-and-response integrated system a more precise maintenance result so that the performance for responding to the report case is improved.

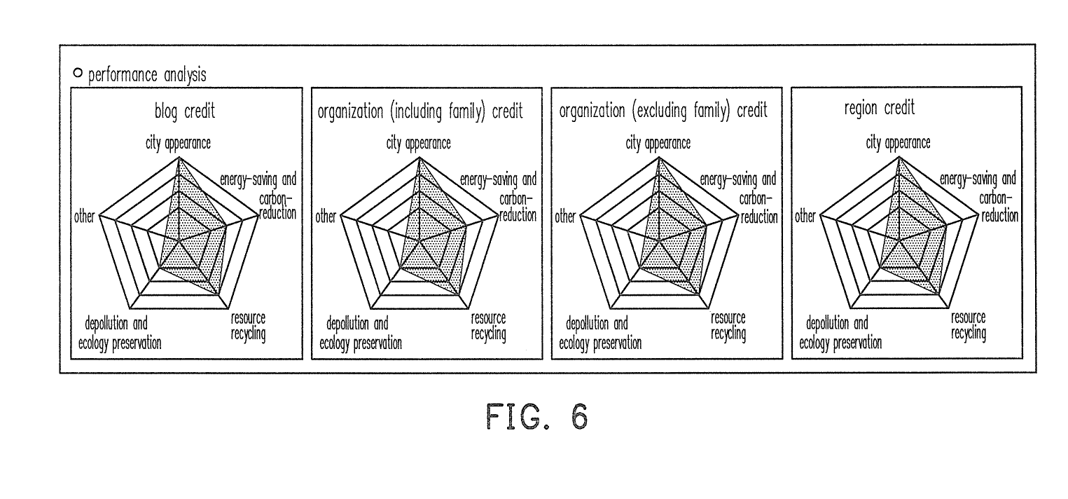

In the present embodiment, as shown in FIG. 1B, the map-oriented report-and-response integrated system 100 further comprises a sign-in module 120 receiving a sign-in information of a reporter. That is, during any one of the steps S101 through S109 in the case report procedure S1101, the reporter can input a sign-in information through the sign-in module 120 (step S119) so as to enter the map-oriented report-and-response integrated system 100. Therefore, the report case filed by the reporter can be related to the personal data corresponding to the sign-in information inputted by the reporter. Hence, after the report case is established, the credit analyzing module 124 in the map-oriented report-and-response integrated system 100, by referring to the nature of the report case, can increase a credit value belonging to the personal data related to the sign-in information of the reporter. Furthermore, after the response in response to the report case is completed by the environmental caretaker of at least one care district in which the positioning point is located, the credit analyzing module 124 further, by referring to the nature of the report case, increases the credit value belonging to the personal data of the environmental caretaker of the care district. FIG. 6 is a schematic diagram showing quantified credit analyzing result in a personal data in the map-oriented report-and-response integrated method according to one embodiment of the present invention. As shown in FIG. 6, the duty performances of the reporter and the environmental caretaker are quantified and classified according to several indexes so as to enhance the participation and the fulfillment of the users of the map-oriented report-and-response integrated system.

Moreover, in the present embodiment, after the response procedure S1103, the map-oriented report-and-response integrated method further comprises a reviewing procedure S117 for actually inspecting the actual location according to the positioning report signal and the response and recording a reviewing result in the reviewing module 126 in order to confirm the validity of the response procedure S1103. Furthermore, the aforementioned reviewing procedure can be displayed on a map in the map-oriented report-and-response integrated system. In other words, in the reviewing procedure in the map-oriented report-and-response integrated system (as shown in FIG. 5), the displayed map shows an inspection route 506, an inspection region 520, and the care district 510.

Altogether, in the present invention, by using the multi-dimensional information menu, a complicated and large number of data can be hierarchically classified into several data nodes and the contents of different data nodes can be displayed on the same viewable region by selecting corresponding menu options. Hence, it is not necessary for the user to search the data by repeatedly clicking sub-options in different data levels under the same main option. The user, by using the multi-dimensional information menu, can easily select options from different menus displayed on the same viewable region of the displayer and then the searched data according to the selected options from different menus are directly shown on the same viewable region. Therefore, the complexity for searching data from a complicated and large number of data is decreased. In addition, classifying the data in the system according to the complex-tree type relation can strengthen the interaction operations of the organizations including announcing announcements, assigning tasks, reporting working results, reviewing performance and rewarding achievement. Moreover, the complex-tree type structure can be used as a medium for mobilizing the organizations to participate an event.

Furthermore, the map-oriented report-and-response integrated system of the present invention is based on the map concept to electronically map the report case and the response in response to the report case so that the performance for responding to the report case is improved. Thus, the problems due to different reading comprehension and poor location description in the conventional paper case report, in which the type of the case and the case location are described in written language can be avoided. Also, by quantifying the performances of the reporter and the person in charging the report case into credit values, the participation and the fulfillment of the users of the map-oriented report-and-response integrated system can be enhanced and the motivation for implementing the tasks and the team spirit of the users can be greatly increased as well. Moreover, the statistic performance can be used as a basis for advertisement matching up or demand-supply matching up between the reporters, the environmental caretakers, the case-handling departments and the case-reporting departments. Thus, the motivation for and the interest in participating in public affairs can be greatly enhanced.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A map-oriented report-and-response integrated method, comprising:
displaying a multi-dimensional information menu, wherein the multi-dimensional menu has at least a first menu, a second menu and a third menu, and the first menu has a plurality of organization options, the second menu has a plurality of topic options and the third menu has a plurality of task options;
selecting one of the organization options from the first menu;
selecting one of the topic options from the second menu;
changing a content of each of the task options according to the selected organization option and the selected topic option so that the changed content is in response to the selected organization option and the selected topic option;
receiving a positioning information;
displaying a map relating to the positioning information;
establishing a report case by receiving a positioning report signal from the map, wherein the positioning report signal includes a positioning point;
performing a maintenance work at an actual location corresponding to the positioning point according to the positioning report signal and taking an image record of the actual location; and
uploading the image record to relate to the report case so as to complete a response in response to the report case.

2. The map-oriented report-and-response integrated method of claim 1 further comprising:
receiving a sign-in information of a reporter;
after the report case is established, increasing a credit value belonging to a personal data according to a nature of the report case, wherein the personal data is related to the sign-in information;
after the report case is established, informing at least an environmental caretaker of at least a care district in which the positioning point is located; and
after the response is completed, increasing the credit value belonging to the personal data of the environmental caretaker of the care district according to the nature of the report case.

3. The map-oriented report-and-response integrated method of claim 1, wherein the maintenance work comprises a global-positioning-system route record and the global-positioning-system route record is consistent with a global-information-system positioning information of the image record.

4. The map-oriented report-and-response integrated method of claim 1, wherein each of the organization options represents an organization and an organization structure of each organization is a tree-type structure and a structure relationship between the organizations is represented as a complex-tree type relation.

5. The map-oriented report-and-response integrated method of claim 1 further comprising performing a reviewing procedure for actually inspecting the actual location according to the positioning report signal and the response.

6. A map-oriented report-and-response integrated system, comprising:
a menu displaying module for displaying a multi-dimensional information menu, wherein the multi-dimensional menu has at least a first menu, a second menu and a third menu, and the first menu has a plurality of organization options, the second menu has a plurality of topic options and the third menu has a plurality of task options;
an organization option selection module for determining one of the organization options from the first menu;
a topic option selection module for determining one of the topic options from the second menu;
a changing module for changing a content of each of the task options according to the selected organization option and the selected topic option so that the changed content is in response to the selected organization option and the selected topic option;
a positioning information receiving module for receiving a positioning information;
a map displaying module for displaying a map relating to the positioning information;
a positioning report signal receiving module for receiving a positioning report signal from the map, wherein the positioning report signal includes a positioning point;
a case establishing module for establishing a report case according to the positioning report signal;
an uploaded file receiving module for receiving an image record and relating the image record to the report case, wherein the image record is taken at an actual location corresponding to the positioning point as a maintenance work is done at the actual location; and
a response module for filing a response to the report case according to the image record.

7. The map-oriented report-and-response integrated system of claim 6 further comprising:
a sign-in module for receiving a sign-in information of a reporter;
an inform module for informing at least an environmental caretaker of at least a care district in which the positioning point is located according to the report case; and
a credit analyzing module for increasing a credit value belonging to a personal data related to the sign-in information of the reporter and increasing the credit value belonging to the personal data of the environmental caretaker of the care district according to the nature of the report case.

8. The map-oriented report-and-response integrated system of claim 6, wherein the maintenance work comprises a global-positioning-system route record and the global-positioning-system route record is consistent with a global-information-system positioning information of the image record.

9. The map-oriented report-and-response integrated system of claim 6, wherein each of the organization options represents an organization and an organization structure of each organization is a tree-type structure and a structure relationship between the organizations is represented as a complex-tree type relation.

10. The map-oriented report-and-response integrated system of claim 6 further comprising a reviewing module for recording a reviewing result, wherein the reviewing result is obtained by actually inspecting the actual location according to the positioning report signal and the response.
